(19) United States
(12) Patent Application Publication
(10) Pub. No.: US 2010/0112224 A1
(43) Pub. Date: May 6, 2010

(54) Methods and formulations for protection ans dust control involving bulk material

(76) Inventor: James A Lott, New Harmony, UT (US)

Correspondence Address: James A. Lott, 738 S. 3430 E, New Harmony, UT, 84757, US

(21) Appl. No.: 12/290,613

(22) Filed: Oct. 30, 2008

(51) Int. Cl. B05D 3/10

(52) U.S. Cl. 427/333

(57) ABSTRACT

A novel two component system is described to apply various formulations for dust suppression and protection of bulk material. The system provides a method to apply the two formulations which result in a temporary, water insoluble, flexible, semipermeable film being formed on the surface to which the formulations are applied. The formulations used for the various applications are described.

### BACKGROUND

1. Field of Invention

The invention relates to a method of protecting material from environmental exposure, such as materials stored or transported in the open air and/or exposed to rain, ice, sun and other environmental factors. The invention also relates to methods of coal dust abatement during loading and unloading of material. This invention uses a two component system that reacts to form a flexible, semipermeable, water-insoluble, biodegradable film that covers or encapsulates material.

2. Description of Prior Art

The problems associated with the transportation, storage, and handling of materials which can freeze and clump together, cause dust problems when loading and unloading the material, has become a major commercial and environmental problem. Such materials are handled in great volume and are transported and stored primarily in open vehicles and containers, exposed to potential precipitation including rain, sleet and snow. The problem is particularly acute in transportation of coal, iron ore and other minerals and small particulate matter conveyed in open rail cars, trucks and barges. As the material is loaded a dust problem is created that leads to the destabilization of the railroad bed ballast and contamination of the surrounding area by the dust being deposited on adjacent properties in large quantities. The moving railroad cars loaded with this material lose a considerable amount of material from each car due to wind erosion to further contaminate a larger area plus they are losing about one ton of coal per car in transit to its use site. In transit the atmospheric moisture plus the moisture in the coal begins to aggregate and collect adjacent to the container walls causing a defined layer of material incorporated ice to harden adjacent to and become attached to the walls. As much as 20% of the material may remain frozen in the car while the purchaser of the material has ordered 100% and received 80% and the shipper has to pay to haul that 20% of the material back to the mining site. If the material freezes in uneven weight distributions, which it often does, the shipper cannot move the car until they have removed the rest of the material in order to keep the cars balanced and avoid potential derailments. This wall adhering frozen portion therefore makes material unloading difficult through normal automated procedures and requires people with chipping tools to enter the partially unloaded containers to manually remove the remaining iced layer stuck on the walls of the container. The material unloaded many times clumps together and makes it impossible for the pulverizers, grizzlies and conveyor belts to handle such large pieces of material. This product will not allow the material sprayed to clump in large pieces that require breaking into smaller pieces to be handled properly at the facility in which it is to be used whether it be a steam generating plant or an ore processing facility.

The fugitive dust problem is one that has plagued the material handling industry for sometime. There has been no product produced that will effectively control this problem until this time. The prior art details several attempts to eliminate this problem but none have proven totally successful. Many disclose compositions contain corrosive materials and substances used on coal and other particulate matter. Some are applied to already frozen material and one has to wait for the material to thaw at every transfer point before unloading. Other inventors have treated the material prior to loading into the vehicles storage containers. U.S. Pat. No. 5,079,036 discloses a brine free control agent which is applied to particulate material such as coal or mineral ores to inhibit freezing aggregation. U.S. Pat. Nos. 5,330,671; 4,971,720; 6,132,638 all disclose methods to suppress coal dust using aqueous based systems involving high oil water emulsions and low salt tolerant surfactants. None have proved to suppress coal dust due to evaporation and many contain elements toxic to humans. This is uneconomical when one considers the millions of tons of such materials shipped every year and the additional cost involved in treating the problem. Many of the previous attempts to prevent freezing and aggregation of material involve ethylene glycol, sodium chloride, potassium chloride and other substances which require special disposal methods. These present environmental health and corrosion hazards.

### SUMMARY, RAMIFICATIONS AND SCOPE

This invention relates to environmentally responsible multi-component compositions, providing a flexible, water insoluble, semi-permeable film that biodegrades over time, which are combined substantially simultaneously with their application to target surfaces, whether they be container surfaces or the surfaces of particulate matter such as coal, mineral ore, or coal dust. This invention protects the environment by not using such materials as ethylene glycol, alkaline earth halides, copolymers and their related petrochemical compounds. More specifically the components of part A contain a percentage of polysaccharides which contain acidic functional groups in at least one solvent while component part B contains polyvalent cations in at least one solvent.

Part A and part B are kept separate until time for application, at which time part A and part B are sprayed, preferably sequentially, and upon mutual contact produce a elastic film which adheres to the surface. The film is water insoluble, flexible, semipermeable and provides a protective cover for the material upon which it has been sprayed

Additional other components such as surfactants (nonionic, anionic, cationic) and antifreeze compounds can be added to reduce the surface tension of part A to allow the droplets to spread further and penetrate deeper into the sprayed material more rapidly and adhere to the surface of particulate matter whether it is coal, mineral ores or particulate matter. The surfactant allows the solution to have air entrained into part A, either from an external source or by mechanical stirring, and cause it to foam to a volume many times the original volume. The viscoelastic properties of part A has a long residual effect because it can be treated with a humectant to retard moisture evaporation, which decreases shrinkage and increases its flexibility. The surfactant reduces the surface tension and assists in entraining air in part A to form a foam that enhances wetting of surfaces it contacts and provides a larger surface area of part A to react with part B.

Additionally an additive can be incorporated into the composition of part A to neutralize the corrosive agents released by some materials or particulate matter. Uses for the tailored compositions of this invention include coating the inside of railroad cars, trucks, and vessels used for the transportation and storage of particulate materials. Transported and stored material may be protected by forming in situ coverings, biodegradable, disposable film and protective wraps. The coverings may be safely disposed of without any substantial impact on the environment.

Uses for the compositions of this invention include coal dust control, dirt dust control, covering stockpiles of particulate matter with a temporary flexible, water insoluble, semi-permeable membrane or film to cover or encapsulate the material to which it is applied so that atmospheric moisture of rain, sleet and snow would not be able to enter the covered materials. It is also designed to prevent aggregation of particulate material and still not interfere with the end use of the material to which it is applied and would not have to be removed from the material. Certain environmentally preferred multipart compositions are applied to particulate material transporting devices such as railroad cars, trucks, barges, wheel barrows and conveyor belts, as well as storage containers. These compositions are biodegradable nontoxic and assist particulate material removal at and below freezing temperatures by preventing the formation of high strength ice crystals within the contained material and between the wall of the devices and the material.

### Antifreeze, Dust and Film Formulations

The compositions of this invention are used to coat the sides of railroad and other vehicles or containers prior to the introduction of the particulate material, to prevent ice bonding the particulate matter to the vessel surfaces. When the two component parts react and cure, they form a thin film that continues to react or cure completely through part A until the component is completely set. Although ice might still form and bond with or to the film, the bond between the ice containing material and the film will not have sufficient strength to prevent the material from routinely falling from the vessel when the vessel is unloaded under normal procedures. The film may be sprayed over the exposed surface of the loaded particulate material to prevent intrusion of moisture into the load and to prevent dusting and loss of particulate material from the load during transit.

The compositions include multiple components which are separately applied to the surface. Individual component parts are preferably kept separate before their application because the rapid reaction between the components results in a semi-solid composition which cannot be applied in an easy manner by a standard single head spray apparatus.

The preferred compositions employs a two part multi-component system. The combination of part A and part B forms a novel composition with substantially improved characteristics over those of either individual part. Part A includes at least one polysaccharide which contains acid functional groups dissolved in at least one solvent. Part A is a thick and viscous, semi-fluid material, especially at low temperatures, and by itself has antifreeze properties which prevents the formation of strong ice crystals. Part A of this invention has a freezing point dictated by the amount of water-soluble organic compounds included in part A and part B, but can be formulated to have a freezing point of minus 40 degrees Fahrenheit. The film strength is dictated by the type and quantity of polysaccharide dissolved in part A.

The percentage of polysaccharide is related to the viscoelastic nature of film that is formed when part A is reacted with part B. The polysaccharide in part A tends to lower the vapor pressure of the composition formed and causes it to remain pliable and flexible for a longer period of time. This film is impervious to all but the strongest concentrations of acids. This is a desirable feature because the strong acids eluted from coal and related particulate matter do not affect the film or its intended function.

The polysaccharides which contain acid functional groups useful in this invention include, singly or a combination thereof, cellulosic materials such as cellulose gum, (carboxymethyl cellulose) and cations salts thereof, including sodium, potassium, and ammonium and calcium salts; polyuronic acids such as soluble alginic acid salts, pectins and cation salts thereof, including sodium, potassium and ammonium salts; and modified starches such as oxidized starches and carboxylated starches, and cation salts thereof, including sodium, potassium and ammonium salts. These biodegradable materials poses no known environmental problems or issues.

Gelatinous materials include gelatin, collagen, gums and salts thereof or a mixture of such materials. Materials such as these proteins are rapidly degraded by environmental forces and present no environmental hazards.

The polysaccharides which contain acid functional groups are effective at levels ranging between about 0.05 to 20% by weight but preferably between about 0.1 percent to about 10% by weight. The gelatinous material may be added in the range of about 0.5 percent to about 20 percent by weight and the preferred range is between about 0.5 percent and about 12 percent by weight.

Part A may be further modified by buffers and various gums and modified gums, such as guar gum, locust bean gum, xanthan gum, modified guar gum, and the like to impart varying properties to the resulting film. Various plasticizers, humectants, surfactants and toughening agents may also be added, such a vinyl or other modified polymers.

Part A is generally dispersed in at least one solvent, preferably water or organic glycols with low toxicity such as propylene glycol, glycerin, or a plurality of such compounds. The solvent of part A ranges between about 60% and about 99% by weight, where the water amount ranges between about 20% and 99% by weight and the organic element is preferably between about 0.1 percent and about 50 percent by weight. Organic glycols, such as propylene glycol and glycerin, also have a plasticizing, elasticizing and antifreeze effect on the film. Other known plasticizers, humectants and elasticizers may also be used.

Part B contains a water soluble polyvalent cation salts in solvent. The polyvalent cation salts include, for example, salts of aluminum, calcium, iron, tin, chromium and zinc, including aluminum nitrate nonahydrate, calcium acetate, calcium citrate, calcium chloride dihydrate and ferric chloride hexahydrate.

The solvent in part B is in part water or an organic glycol with low toxicity such as propylene glycol, glycerin, alkoxytriglycols, alkoxydiglycols or hydroxyethyl pyrrolidone, which also contributes antifreeze properties to the film formed.

The polyvalent cation concentration should range between about 0.001 percent and about 20 percent by weight and preferably between about 0.006 and 14 percent by weight. The water portion of solvent ranges between approximately 20 percent and about 99 percent by weight, whereas the organic element ranges between about 1 percent and approximately 50 percent by weight.

The antifreeze compositions include single elements or a plurality of elements, such as a plurality of polysaccharides which contain acid functional groups or a plurality of polyvalent cation salts. Different polysaccharides which contain acid functional groups form films with different properties when they contact polyvalent cations. A film containing cellulosic material is a very smooth even textured gel whereas alginic acid containing films provide a more rigid uneven gel, though much sturdier than a cellulose containing gel. Therefore, applications may require a mixture of such acid containing polysaccharides to product the required consistency. Similarly, different polyvalent metal cation salts have different stabilizing properties and different costs, so often a combination of such form the properties needed for a particular composition.

The two parts are applied in the following general method. In the preferred practice, part A and part B are placed in individual pressure spray units and sprayed under pressure to form a uniform film layer adjacent to and adhering to the surface of all components. Preferably the separate components are applied with sprayers, but mechanical methods of application including brushes, rollers or sprayers, along or in conjunction with spraying can be utilized to apply some portion of the composition. Part A and part B are placed in separate containers connected to separate Wagner 2500 pressure spray units. The unit containing part A is activated and the surface of the vessel or particulate matter is sprayed with an even movement of the spray head so an even layer of part A is placed in a strip about two feet wide. The unit containing part B is activated and the spray head is directed to cover the part A material that was sprayed in the previous step. This is done because part A formulation retains the acid containing polysaccharides on the vessel walls for reaction with the cross linking polyvalent cations in part B to form a uniform film (gel) on the surface as the two parts interact. The spray unit pressures used depend on the viscosity of part A and part B, and range from approximately 40 psi to approximately 2500 psi, 250 psi to 350 psi is best, but about 300 psi is preferred. The effective flow rate range of part A is between about 0.2 gallon per minute and about 1.75 gallons per minute per spray head, but the preferred rate is about 0.5 gallon per minute per spray head. The flow rate range for spraying part B is between about 0.1 gallon per minute and about 1.8 gallon per minute with the preferred rate being about 0.2 gallon per minute per spray head to ensure the entire surface of part A is covered with part B.

Alternatively, the components are mixed in a single spray mixing nozzle substantially immediately prior to the outlet orifice so the mixing is improved and the film forms much faster. The pressurized spray method of application, in addition to the beneficial ease, speed and low cost properties, also produces a beneficial air rich environment which assists oxidation of any reduced metal ion to higher valency forms for improved reaction with the polysaccharides.

The polyvalent metal salts in part B are also critical to the formation of the gels and films. The polyvalent metal cation salts react with the higher molecular weight polysaccharides and proteins in part A and become intertwined, resulting in a strong film. Higher concentrations of such inorganic salts rapidly form firmer water insoluble films. Iron (III) appears to be the best of all around polyvalent ion for this part. Al (III) tends to be cost prohibitive, and Ca (II), although cost effective, does not yield as strong a film as the other ions. Specifically, calcium ion causes a film or gel to form initially, but an excess amount of calcium ion weakens the gel formed and causes it to liquify, so the use of excess calcium should be avoided. Other metal ions are either cost prohibitive or have adverse environmental, corrosive and health effects associated with their use.

Each of the components, part A and part B may contain specific additives which will be included, based on the ultimate utilization of the invention's compositions. For example, surfactants, such as anionic surfactant, sodium lauryl sulfate, may be utilized to decrease the surface tension of the solution and promote bubble formation in the application of part A and improve its adhesion to the particles or surface sprayed, as well as expose more of the surface area of part A to part B, hence creating a faster reaction and a stronger film. Nonionic surfactants, such as aromatic ethoxylates, those with amide groups, alcohol ethoxylates, modified ethoxylates can also be used in the formulation of part A.

The following examples further illustrate the invention but are not to be construed as a limitation on the scope of the invention. Example 1 details the specific components elements and procedure for producing a composition useful in protecting the surfaces of particulate material storage and transportation vessels, such as rail cars and barges. All percentages are calculated on a weight percent basis.

### EXAMPLE 1

| Part A | Part B |
|---|---|
| 5% ghetti gum | 5% calcium chloride dihydrate |
| 2% alginic acid (soluble salt) | 40% propylene glycol |
| 22% glycerin | 50% water |
| 71% DI water | |

The water was added to the vessel and vigorously agitated using a device which created a vortex into which the ghetti gum was gradually introduced. There was a noticeable increase in the viscosity noted during this procedure. A predetermined amount of alginic acid (sodium salt, heavy viscosity grade, Frutarom Corp., North Bergen, N.J.) was introduced into the solution noting a greater increase in the viscosity of the solution. The solution appeared clear, but not necessarily colorless due to the nature of the compounds being dissolved. The remaining quantity of glycerin (Eastman Chemical, Kingsport, Tenn.) Was added to the vigorously stirred solution until the solution was homogeneous.

Part B was prepared by measuring out the appropriate amount of calcium chloride dihydrate and dissolving it in water. The quantity of polyvalent metal salt should be no less than about 1/12th the weight of the combined polysaccharides used in part A. The water soluble elasticizer antifreeze, glycerin, was then added and the solution was stirred vigorously for approximately twenty minutes to ensure complete and homogeneous distribution of the polyvalent metal ion.

Part A was placed in the container of a Wagner 2500 high pressure spraying machine capable of providing at least 100 psi at the nozzle, and the sprayer primed. Part B was then placed in a hand operated pressure spray bottle, and the pump was also primed by squeezing the trigger several times, while adjusting the spray nozzle to a fine mist.

The nozzle of the Wagner unit containing part A was aligned parallel and perpendicular to the surface to be sprayed. The sprayer nozzle was held approximately two feet from the surface to be sprayed. The Wagner spray unit was activated and the solution was released in a flat, fan-shaped fine spray mist while moving the nozzle parallel to the surface. The preferred flow rate was about 0.5 gallon per minute for the application of part A.

Upon completion of spraying part A on the surface, the hand operated spray bottle containing part B is operated so the fine most of part B covers any of the surface that contains part A. The preferred flow rate for spraying part B was about 0.2 gallon per minute.

Part A and part B react to form a film which adhered to the surface to which it is applied. Upon setting for a short period of time the film developed greater strength, became less fluid and more rigid.

Antifreeze and Corrosion Control—Two Component System

Moisture due to the freeze thaw weather patterns, causes corrosive compounds to leach out of particulate matter, such as coal and mineral ores during transport. Storage containers and vehicles such as railcars and truck beds are made of iron and aluminum and tend to rust and corrode upon contact with these corrosive compounds. This corrosive action shortens the expected lifetime of such containers and vehicles. Many unsuccessful attempts have been made to alleviate this corrosion problem. A corrosion control agent is incorporated into the antifreeze formulation of this invention to aid in the unloading of the vessels and reduce the corrosion and extend the life of the transporting vessels.

A two component system which forms a water insoluble, nontoxic, biodegradable film or gel containing a corrosion control agent homogeneously distributed throughout prevents the corrosion agents attaching the metal surfaces, thus extending the vessel's useful life.

Possible corrosion control agents include calcium carbonate, dolomite, magnesium carbonate and other insoluble metal compounds which are able to neutralize corrosive acids, yet prove to be environmentally compatible with the intended use of the contained material. The presence of calcium compounds as corrosion control agents do not weaken the resulting antifreeze gels as soluble calcium salts do when used in similar amounts as a polyvalent cation source, because these agents are water insoluble and do not interact with the gel or film forming mixture.

The Wagner sprayer unit exhibits pressures from about 40 psi to 2500 psi, 250 to 350 psi is best, but about 300 psi is preferred. The effective flow rate range of part A is held to be about twice that of part B because of the desired concentration of the two parts and ranged between about 0.25 gallon per minute and about 1.75 gallon per minute, but the preferred rate is about 0.5 gallon per minute. The slow rate range for spraying part B is between about 0.1 gallon per minute and about 1.8 gallons per minute with the preferred rate being about 0.2 gallon per minute. The spray heads are moved parallel to the surface to apply a uniform of antifreeze ranging between about 1/1000 inch and about ¼ inch with the preferred range being between about 1/32 inch and about ⅛ inch.

The resulting film is impervious to all but the strongest of acids. This is desirable because the strong corrosive acids eluted from the transported material can react with the polyvalent cation to weaken the gel film. Even if some gel film deterioration occurs, the exposed portion of the gel layer provides for additional corrosion control agent to neutralize the excess corrosive matter, thereby arresting further deterioration and corrosion of the container metal.

Corrosion control agents such as dolomite can be added to either or both part A and part B as it is not soluble in either. The corrosion control agents are included in the range between about 10 percent and about 50 percent and preferably between about 15 and 30 percent. Other corrosion inhibitors such as antioxidants, for example BHT, BHT and ascorbic acid may be added to protect structures or articles susceptible to oxidation. Ultra violet light inhibitors and blockers, including carbon black and equivalent inhibitors may be added, especially where longer term outdoor exposure is contemplated.

The water insoluble property of this film serves two functions. The film is not washed off or penetrated by atmospheric moisture. Corrosive acids will be neutralized upon contact with the corrosion control agent.

A mixture of polysaccharides which contain acid functional groups can be used in part A to modify the gel film properties. A preservative may be used in part A, e.g. 1% Dowasil 75, to prevent attack by bacteria and mold if polysaccharides other than cellulosic materials are used. Other known preservatives may be used, such as propionic acid and salts thereof and other fungistates, fungicides and bactericides.

A specific formulation and procedure for application is included in example 2 below. The percentages are based on a total weight basis.

### EXAMPLE 2

| Part A | Part B |
|---|---|
| 1.2% alginic acid (soluble salt) | 48% propylene glycol |
| 44.8% DI water | 47% water |
| 34% propylene glycol | 5% calcium acetate |
| 20% dolomite | |

Part A was prepared by determining the weight of total solution to be prepared. The predetermined mass of water was added to the vessel and stirred vigorously while adding the appropriate amount of alginic acid (soluble salt) to the vortex of the solution. There was a dramatic increase in the viscosity noted during this procedure. A clear, not necessarily colorless, solution was produced. The propylene glycol was slow introduced until the solution was homogeneous and then the dolomite was slowly added to ensure it did not lump and the vigorous stirring continued until the dolomite was evenly distributed throughout the system.

Part B was prepared by dissolving the appropriate amount of calcium acetate in water. The propylene glycol was added and the solution stirred for approximately 15 minutes. The solution was stored until ready for use.

The composition components were applied through apparatus similar to that used in Example 1. Part A was placed in the container of a Wagner 2500 spray unit. The unit was primed and turned off. A magnetic stirrer (Corning model PC-310) under the Wagner sprayer container was used to agitate the part A solution to ensure the dolomite and other insoluble materials were homogeneous through the solution.

Part B was placed into a hand-powered pump misting spray bottle.

Part A was sprayed onto the surface in a horizontal motion parallel to the surface, producing a two foot wide spray pattern. The distance from the surface to be covered was dictated by the pressure and design of the spray. The usual distance was between two and three feet from the surface. Part A was applied at about 0.5 gallon per minute under approximately 300 psi pressure and part B was applied immediately onto part A at a rate of 0.25 gallon per minute using a hand powered misting bottle.

The dolomite suspended in the viscous part A was homogeneously distributed throughout part A sprayed onto the surface and remained in position, because the gel film formed when part B was sprayed onto part A did not allow the dolomite to migrate or settle out of solution. This property provides protection from any corrosive acids eluting from the material being carried.

A simulation of the effect of the corrosive leachate on the gel film containing a corrosion control agent was performed. A solution of 1 molar hydrochloric acid was applied to portions of gel film, but a small amount of effervescence was evident as the corrosion control agent neutralized the acid, as evidenced by measuring the pH of the acid in 3 minutes. It reached pH=7, therefore it was neutralized and non-corrosive to the metal.

The insoluble nature of the gel film in both water and dilute acids, plus dolomite's reaction with eluted acid from the particulate material was very effective in reducing costly corrosion caused by such agents.

### EXAMPLE 3

A dust abatement system may be prepared as a two part system as follows:

Part A is prepared as described in example 1 as a solution/dispersion containing 3 percent by weight sodium alginate, 82 percent by weight deionized water, 15 parts by weight glycerin.

Part B is prepared as described in example 1, as a solution containing 8 percent by weight calcium acetate and 92 percent by weight water.

Part A and part b are sprayed into the material loading area to coat the material being loaded. Part A is placed in a spray unit spraying about one foot ahead of the spray unit spraying part B into and onto the material. The loaded material allows part A to contact part B and the mutual contact initiates the gel film formation. The gel film contacts holds and encapsulates the dust particles. This prevents them from becoming airborne.

### EXAMPLE 4

A protective film of liquatarp for exposed particulate material may be prepared as a two part system as follows:

Part A may be prepared, as described in example 1, as a solution/dispersion containing 2 percent by weight sodium alginate, 90 percent by weight water, 8 parts by weight glycerin.

Part B is prepared as described in example 1, as a solution containing 5 percent by weight calcium acetate or other polyvalent cation salt with 95 percent by weight water.

Parts A and B are sprayed through separate sprayers as described in Example 1, onto the surface of a gravel load contained in a transport vessel. The film of coating forms in situ on the exposed surface of the gravel load and forms a substantially continuous film covering the gravel load and confining the gravel to the vehicle. The film covered load may be subjected to bumps and agitation by driving over surface bumps at speeds consistent with work conditions. The film will remain pliable, flexible, water-proof, insoluble and retain loose particles in the vehicle and protect the material from atmospheric moisture and eroding wind. The load may be dumped into storage. The film will not interfere with removal of the load from the vehicle and the load will break up into loose gravel when dumped. Any film remaining within the truck will biodegrade within 30 days and not allow or permit build-up of material within the vehicle container.

### EXAMPLE 5

A protective film of liquatarp for exposed particulate material may be prepared as a two part system as follows:

Part A may be prepared as described in Example 1, as a solution/dispersion containing 2 percent by weight sodium alginate, 20 percent by weight glycerin, 8 percent by weight sodium lauryl sulfate and 70 percent by weight deionized water.

Part B may be prepared as described in Example 1, as a solution containing 8 percent by weight calcium acetate, 92 percent by weight water.

Part A was subjected to high speed sheer to entrain air into part A until it became 3 to 4 times the original volume of the solution. This had the texture of shaving cream as it was a thick creamy foam. This foam was sprayed onto the surface of the particulate matter using a foam spraying gun in a motion parallel but horizontal to the surface of the particulate matter. The foam of part A was allowed to settle and penetrate into the particulate matter for 5 minutes. This time to allow penetration by part A could be increased to an hour.

Part B was sprayed onto the surface of the foam in a fine mist from a pressurized spray bottle until the foam was uniformly covered.

The film forms immediately upon the contact of part B with part A and the strength of this film would increase with time due to the continuing reaction that occurs between part A and part B. This film would have greater strength than part A when it is not foamed, because more of the active components of part A are exposed to the action of part B, resulting in a greater total reaction between part A and B.

Accordingly, the reader will see this invention can be used in dust abatement, freeze control and protect stockpiled or transported coal and particulate matter from atmospheric moisture or wind erosion. This invention has additional advantages in that
it produces a film that does not have to be removed from the material to which it is applied;
it biodegrades
it provides a superior film for particulate containment on transported material;
it provides protection from atmospheric moisture and wind erosion to stored and transported material;
it effectively bonds the sprayed material together and prevents the loss of material due to wind erosion;
it provides superior dust abatement because of its low surface tension and can be sprayed into and on the material being loaded;
it provides a flexible film that won't evaporate readily and doesn't break down under normal agitation;
it can be foamed to increase its coverage area with no loss of the film's characteristics;
it will prevent corrosive acids in transported material from corroding the metal transport containers;
it can be applied to any shape object;
it adheres to the vertical sides of transporting vessels;
it contains no known toxic material in its formulations;
it is applied with a novel two-part system;

There has been shown and described novel means for an environmentally sound antifreeze and covering compositions and uses without ethylene glycol or alkaline earth halides. The present invention fulfills all the objects and advantages set forth above. It will be apparent to those skilled in the art, that many changes, modifications, variations and other uses and applications for the subject invention are possible. All such changes, modifications, variations and other uses and applications which do not depart from the spirit and scope of the invention are deemed to be covered by the invention, which is limited only by the claims which follow.

I claim:

1. A method of applying a flexible, water insoluble, semipermeable, biodegradable film to the vertical and horizontal surface of a container or material the composition of which is comprised of
a part A component comprised of a water solution containing a sodium, potassium or ammonium salt of alginic acid containing acid functional groups and a separate
part B component comprised of a water containing solution of a polyvalent cation selected from the group consisting of water soluble calcium, aluminum and iron salts.
The alginic acid composition being present in part A in an amount between about 0.1 and 20 percent by weight, and polyvalent cation salt being present in part B in the amount between about 0.001 and 30 percent by weight
and wherein part A and part B are sprayed through pressurized sprayers, at rates over about 0.1 gallon per minute, mixing said components together and allowing the composition to react and form a cross-linked gel or film layer which is pliable, flexible and water insoluble.

2. The method of claim 1 wherein the sprayers mix the components immediately prior to applying to said surface.

3. The method of claim 1 comprising spraying part A as a foam, air being entrained into part A, wherein the components are applied at flow rates between about 0.2 gallon and 1.8 gallons per minute.

4. The method of claim 1 wherein the film of gel layer has antifreeze components in the formulation.

5. The method of claim 1 wherein part A contains a surfactant between about 1 and 15% percent by weight.

6. The method of claim 1 wherein the sprayer mix the components immediately prior to exiting the sprayer head.

7. The method of claim 1 wherein the film is between 1 to 250 mil thick.

8. The method of claim 1 wherein part A is sprayed onto a surface, followed by part B to initiate the film forming process.
